(19) United States
(12) Patent Application Publication
(10) Pub. No.: US 2005/0122048 A1
(43) Pub. Date: Jun. 9, 2005

(54) Surface light source device and liquid crystal display device having the same

(76) Inventors: Seock-Hwan Kang, Suwon-si (KR); Min-Gyu Kim, Seoul (KR); Gi-Chang Park, Seoul (KR); Hea-Chun Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/004,719

(22) Filed: Dec. 3, 2004

(30) Foreign Application Priority Data
Dec. 5, 2003 (KR) 2003-87920
Jan. 12, 2004 (KR) 2004-1913

(51) Int. Cl. H01J 61/35; H01J 17/16; H01J 1/62

(52) U.S. Cl. 313/635; 313/495; 349/70

(57) ABSTRACT

A surface light source device having improved electrical and mechanical characteristics is provided. The surface light source device includes a light source body including a discharge space to generate a light source, at least one external electrode, which is disposed on an outer surface of one end of the light source body, is extended in a first direction, and applies a discharge voltage to the discharge space, and at least one power transfer unit, combined with the at least one external electrode, to apply the discharge voltage to the at least one external electrode. The at least one power transfer unit is a clip-shaped and clips on the at least one electrode disposed on the outer surface of the light source body.

### BACKGROUND OF THE INVENTION

1. Field of the Invention

The present invention relates to a surface light source device and liquid crystal display device having the same. More particularly, the present invention relates to a surface light source device in which an external electrode is disposed on an outer surface of a light source body and a power transfer unit that connects the external electrode to an inverter to provide a discharge voltage to the external electrode, and a liquid crystal display device having the same.

2. Description of the Related Art

Information-processing devices display processed information via display devices such as liquid crystal display (LCD) apparatuses. LCD apparatuses display images using liquid crystals. The apparatuses have been widely used in various fields, because LCD apparatuses have many advantages such as thinner, lighter, low power consumption, low driving voltage, etc.

LCD apparatuses include a liquid crystal display panel for displaying images and a backlight assembly for providing light to the LCD panel. Backlight assemblies are classified as either an edge type backlight assembly or a direct lumination type backlight assembly. An edge type backlight assembly includes a light source disposed on a side surface of a light guide plate. The light generated from the light source is radially reflected through one surface of the light guide plate, and provided to a LCD panel. A direct lumination type backlight assembly includes a plurality of light sources disposed under a LCD panel, a diffusion plate disposed over the light source, and a reflection plate disposed under the light source. The direct lumination type backlight assembly has high brightness but does not have uniform brightness, while the edge type backlight assembly has low brightness and uniform brightness.

Backlight assemblies further include a light guide plate, a diffusion member and an optical member such as a prism sheet to improve brightness and uniformity of the brightness when a cold cathode fluorescent lamp (CCFL) or a light emitting diode (LED) is used as a light source. Therefore, LCD apparatuses in which CCFLs or LEDs are used as light sources have increased volume and weight, resulting in increased manufacturing costs. Recently, surface light source devices have been developed in which discharging is used to provide a light source.

Surface light source devices include internal or external electrodes to generate a light source in response to a discharge voltage. The discharge voltage is applied to the electrodes through a plurality of wires withdrawn from an external power supply unit. The wires are connected to the electrodes via a soldering process.

Although a soldering process may improve an electric characteristic between the wires and the electrodes, the connection may be easily broken due to an external impact. Further, the electrodes may be damaged by heat generated during the soldering process. Furthermore, the wires are tied to one pair in order to be directly connected to the electrodes, resulting in a complicated process for manufacturing the surface light source.

### BRIEF SUMMARY OF THE INVENTION

The present invention provides a surface light source device having electrically improved properties.

The present invention also provides a liquid crystal display device having the above surface light source device.

According to one aspect of the present invention, a surface light source device, comprises a light source body including a discharge space to generate a light source; at least one external electrode, which is disposed on an outer surface of one end of the light source body, is extended in a first direction, and applies a discharge voltage to the discharge space; and at least one power transfer unit, combined with the at least one external electrode, to apply the discharge voltage to the at least one external electrode.

According to another aspect of the present invention, a liquid crystal display device, comprises a surface light source, including: a light source body including a discharge space to generate a light source; and at least one external electrode, which is disposed on an outer surface of one end of the light source body, is extended in a first direction, and applies a discharge voltage to the discharge space; at least one power transfer unit, combined with the at least one external electrode, to apply the discharge voltage to the at least one external electrode; a receiving container to receive the surface light source; and a liquid crystal display unit, disposed on an upper of the surface light source, to display an image with the light source generated from the surface light source.

According to the present invention, the surface light source device and the liquid crystal display device have improved electric properties thereof because a discharge voltage is applied to the first and second external electrodes through at least one power transfer unit.

This application relies for priority upon Korean Patent Application No. 2003-87920 filed on Dec. 5, 2003, the contents of which are herein incorporated by reference in its entirety.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing a surface light source device according to an exemplary embodiment of the present invention;

FIG. 2 is a cross-sectional view taken along the line A1-A2 of FIG. 1;

FIG. 3 is a perspective view showing a power transfer unit according to an exemplary embodiment of the present invention;

FIG. 4 is a perspective view showing a power transfer unit according to another exemplary embodiment of the present invention;

FIG. 5 is a cross-sectional view taken along the line B1-B2 of FIG. 4;

FIG. 6 is a perspective view showing a power transfer unit according to another exemplary embodiment of the present invention;

FIG. 7 is a perspective view showing a surface light source device according to another exemplary embodiment of the present invention;

FIG. 8 is a perspective view showing the surface light source device shown in FIG. 1;

FIG. 9 is a cross-sectional view taken along the line C1-C2 of FIG. 8;

FIG. 10 is a plane view showing the space-dividing walls of the surface light source device of FIG. 8;

FIG. 11 is a perspective view showing a surface light source device according to another exemplary embodiment of the present invention;

FIG. 12 is a cross-sectional view taken along the line D1-D2 of FIG. 11;

FIG. 13 is a cross-sectional view taken along the line E1-E2 of FIG. 11;

FIG. 14 is a partially enlarged view showing the power transfer unit of FIG. 11;

FIG. 15 is a partially enlarged view showing a power transfer unit according to another exemplary embodiment of the present invention; and

FIG 16 is an exploded perspective view showing a liquid crystal display device according to an exemplary embodiment of the present invention;

FIG. 17 is an enlarged view showing a portion of a receiving container shown in FIG. 16; and

FIG. 18 is an exploded perspective view showing a liquid crystal display device according to another exemplary embodiment of the present invention.

### DESCRIPTION OF THE INVENTION

Hereinafter, the present invention will be explained in detail with reference to the accompanying figures.

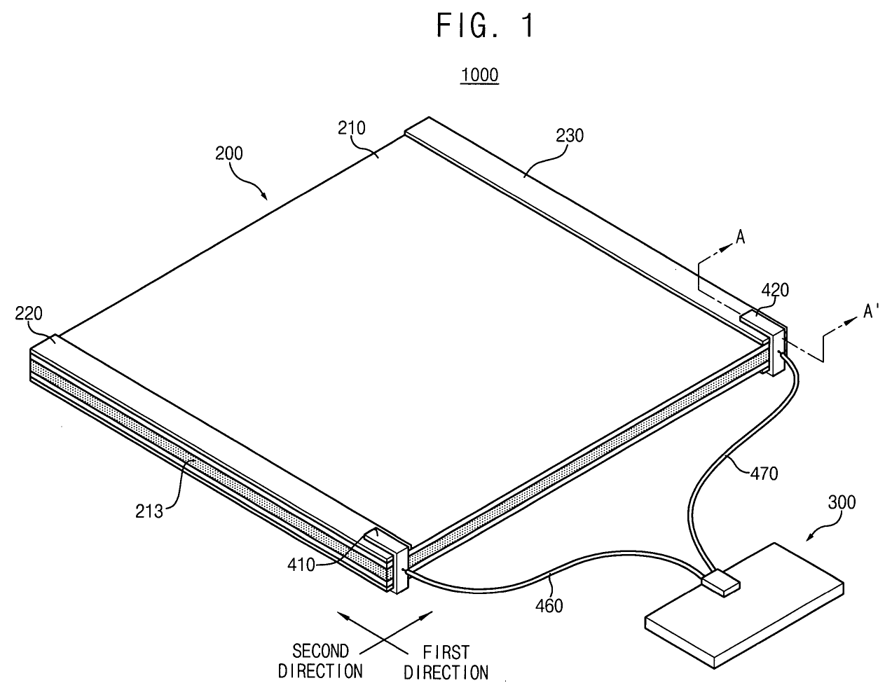

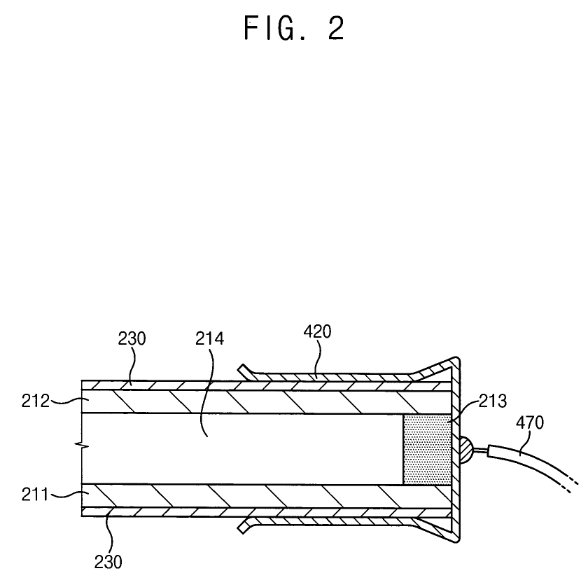

FIG. 1 is a perspective view showing a surface light source device 1000 according to an exemplary embodiment of the present invention. FIG. 2 is a cross-sectional view taken along the line A1-A2 of FIG. 1. The surface light source device 1000 according to an exemplary embodiment includes a surface light source 200, an inverter 300, a first power transfer unit 410 and a second power transfer unit 420.

The surface light source 200 includes a light source body 210, a first external electrode 220 and a second external electrode 230. The light source body 210 includes a first substrate 211, a second substrate 212 facing the first substrate 211 and spaced apart from the first substrate 211, and a sealing member 213 disposed along ends of the first and second substrates 211 and 212 to seal a discharge space 214 between the first and second substrates 211 and 212. The discharge space 214 generates a light source using a discharge gas in response to a discharge voltage received from the external electrodes 220 and 230.

The first and second substrates 211 and 212 each include a glass substrate, which transmits visual rays but blocks ultraviolet rays. The first substrate 211, for example, has a thickness substantially identical to that of the second substrate 212. The sealing member 213 may be formed on the first and second substrates 211 and 212 by a separate process, be integrally formed with the first substrate 211 or the second substrate 212 or be removed in case of integrally forming the first substrate 211 with the second substrate 212.

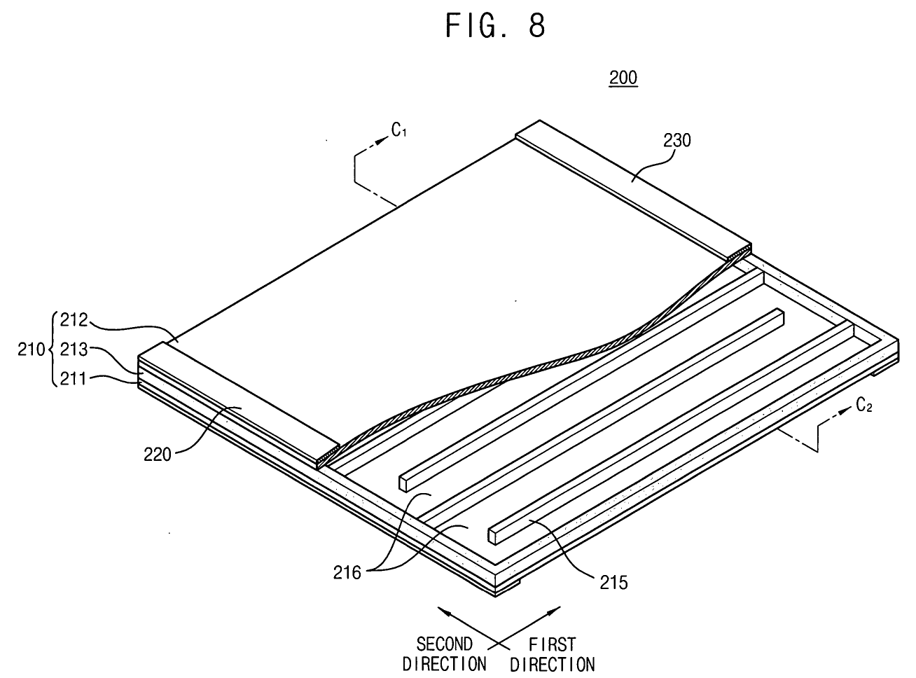

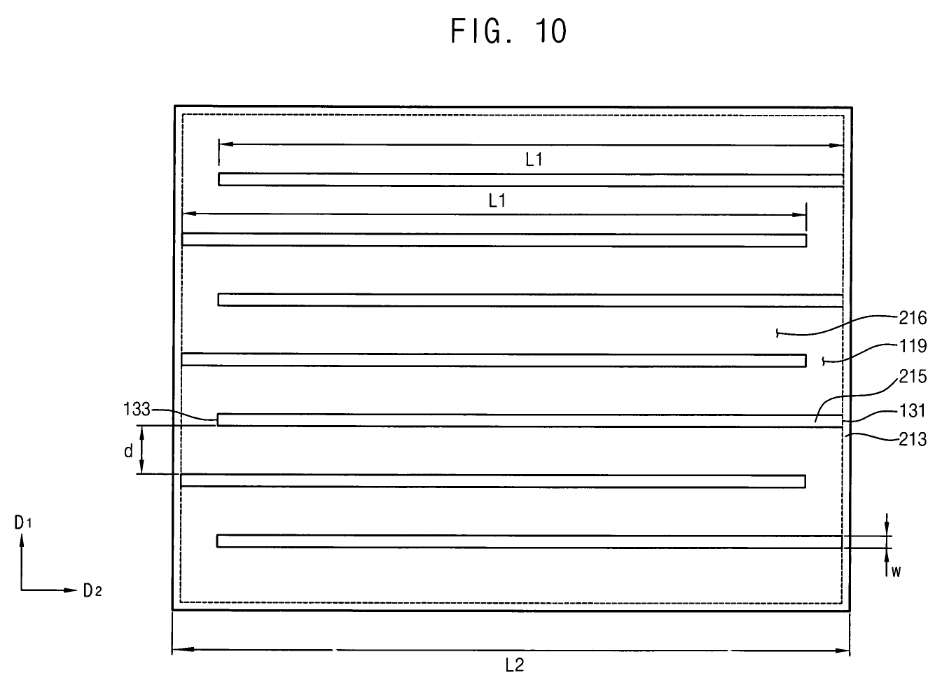

The discharge space 214 may be divided into at least two discharge areas 216 by at least one space-dividing member 215, with respect to FIGS. 8-10 showing the surface light source device more detail. Referring FIGS. 8-10, a plurality of the space-dividing members 215 is arranged with spaces between each member 215 and in parallel to each other in a first direction D1. Each member 215 extends in a second direction D2 substantially perpendicular to the first direction D1. Each of the space-dividing members 215 has, for example, a bar-shape, which is extended in the second direction D2. The bar-shape has a width “W” and a length “L1” shorter than a length “L2” of the sealing member 213 in the second direction D2.

Each space-dividing member 215 has one end 131 connected to an inner side surface of the sealing member 213 and the other end 133 placed apart from an opposite inner side surface of the sealing member 213. Each space-dividing member 215 further includes upper and lower portions making contact with the first and second substrates 211 and 212, respectively, by an adhesive member. The space-dividing members 215 are spaced apart from each other in a predetermined interval “d” and the first ends 131 or second ends 133 of the space-dividing members 215 are alternatively spaced apart from the sealing member 213, so that the space-dividing members 215 are arranged in a zigzag shape.

Because the space-dividing members 215 are arranged in a zigzag between the first and second substrates 211 and 212 in the first direction D1, a connection path 119 is formed to connect the discharge areas 216. A discharge gas is uniformly flowed into the discharge areas 216 through the connection path 119. Alternatively, the surface light source device 1000 may have a sealed discharged area without forming the connection path 119 in which the first and second ends 131 and 133 of the space-dividing member 215 make contact with the sealing member 213. In this case, each space-dividing member 215 may have a hole formed therethrough so as to uniformly distribute the discharge gas into the discharge areas 216.

The space-dividing members 215 may be formed with a different material from or an identical material to that of the sealing member 213. When the space-dividing members 215 are formed with an identical material to that of the sealing member 213, the space-dividing members 215 may be formed with the sealing member 213 at the same time.

The first and second external electrodes 220 and 230 are formed on outer surfaces of opposite ends of the light source body 210, respectively, and are extended in the first direction D1. Although FIG. 1 shows the first and second external electrodes 220 and 230 formed on both upper and lower outer surfaces of the light source body 210, the first and second external electrodes 220 and 230 may be formed on only an upper outer surface or only a lower outer surface of the light source body 210.

The first and second external electrodes 220 and 230 receive a discharge voltage so as to make the discharge space 214 in a discharge state. For example, the first and second external electrodes 220 and 230 include a material having a superior conductivity, for example, such as copper (Cu), nickel (Ni), aluminum (A1) tape, silver (Ag) paste and so on. Also, the first and second external electrodes 220 and 230 have a surface area suitable for supplying excitation energy inside the surface light source 200.

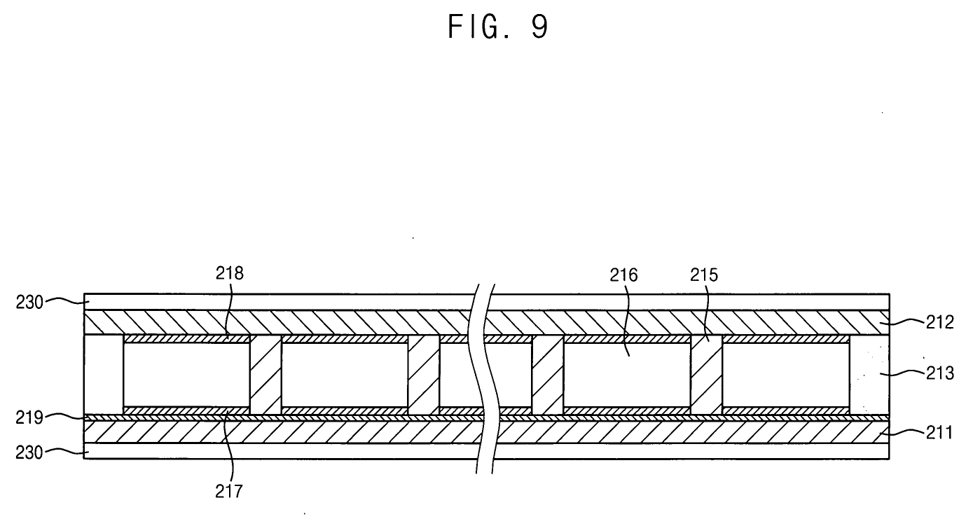

The surface light source 200 further includes a first fluorescent layer 217 and a second fluorescent layer 218 facing each other. The first and second fluorescent layers 217 and 218 are formed on an inner surface of the first and second substrates 211 and 212, respectively, except for an area on which the space-dividing members 215 are formed. Although not shown in FIG. 9, the surface light source 200 may further include a fluorescent layer formed on side surfaces of the space-dividing members 215. The first and second fluorescent layers 217 and 218 emit visual rays in response to the ultraviolet rays generated by plasma in the discharge space 214.

Furthermore, the surface light source 200 includes a reflecting layer 219 formed between the first substrate 211 and the first fluorescent layer 217. The reflecting layer 219 reflects the visual rays generated by the first and second fluorescent layers 217 and 218 to the second substrate 212. The surface light source 200 still further includes a protection layer (not shown), which may be formed between the second substrate 212 and the second fluorescent layer 218 and between the first substrate 211 and the reflecting layer 219. The protection layer prevents mercury (Hg) that is a basis of the discharge gas injected into the discharge space 214 from being chemically reacted to the first and second substrates 211 and 212.

The first and second external electrodes 220 and 230 disposed on the outer surface of the light source body 210 receive a discharge voltage from the inverter 300 (FIG. 1), and are connected to the inverter 300 through the first and second power transfer units 410 and 420, respectively. Referring to FIGS. 1 and 2, the first and second power transfer units 410 and 420 are combined with both ends of the light source body 210 on which the first and second external electrodes 220 and 230 are disposed. The first and second power transfer units 410 and 420, for example, each have a clip-shaped. Particularly, the first and second power transfer units 410 and 420 clip on the first and second external electrodes 220 and 230 disposed on the light source body 210 toward the first direction D1, and electrically connect to the first and second external electrodes 220 and 230, respectively.

The inverter 300 provides a discharge voltage to the surface light source 200 so as to generate discharge in the discharge space 214, and the discharge voltage is applied to the surface light source 200 from the inverter 300 through first and second power lines 460 and 470 and the first and second power transfer units 410 and 420. The first and second power lines 460 and 470 electrically connect the first and second power transfer units 410 and 420 to the inverter 300. For example, the first and second power lines 460 and 470 may be operatably fixed to the first and second power transfer units 410 and 420 by a soldering process, respectively. Therefore, the discharge voltage generated from the inverter 300 is applied to the first and second external electrodes 220 and 230 through the first and second power lines 460 and 470 and the first and second power transfer units 410 and 420.

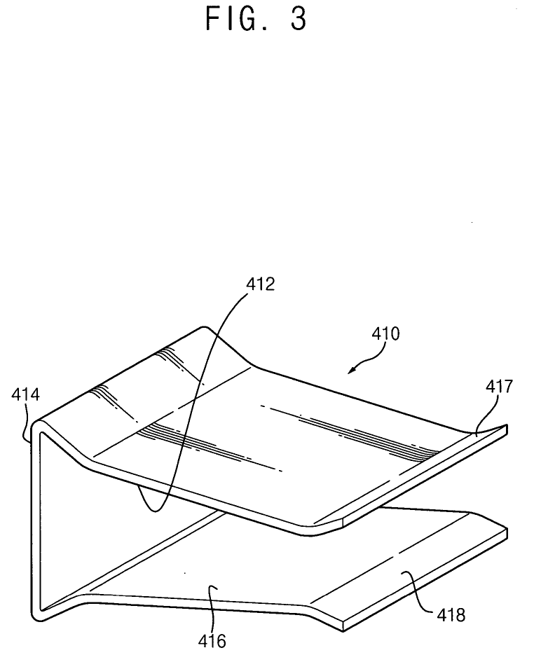

FIG. 3 is a perspective view showing the first power transfer unit 410 shown in FIG. 1. In this exemplary embodiment, the second power transfer unit 420 has a structure substantially identical to that of the first power transfer unit 410, and thus a detailed description of the second power transfer unit 420 will be omitted.

Still referring to FIG. 3, the first power transfer unit 410 includes a conductive material having an elastic force in a direction perpendicular to the first and second directions D1 and D2. The first power transfer unit 410 includes a first surface 412 configured to make contact with the upper surface of the first external electrode 220 disposed on the upper outer surface of the light source body 210, a second surface 414 downwardly extended from the first surface 412 and disposed on a side outer surface of the light source body 210, and a third surface 416 extended from the second surface 414 and configured to make contact with the lower surface of the first external electrode 220 disposed on with the lower outer surface of the light source body 210. The first and third surfaces 412 and 416 face each other.

The first power transfer unit 410 clips on the first external electrode 220 disposed on the light source body 210 while advancing from the side surface of the light source body 210 in the first direction D1. In order to easily clip the first power transfer unit 410 on the light source body 210, the first and third surfaces 412 and 416 may have bent portions 417 and 418 outwardly extended from ends of the first and third surfaces 412 and 416. The first power transfer unit 410 clips on the first external electrode 220 disposed on the light source body 210 and fixes to the first external electrode 220 and the light source body 210 with the elastic force of the first and third surfaces 412 and 416.

In order to enhance the elastic force of the first and third surfaces 412 and 416, the first power transfer unit 410 may further include a spring (not shown) interposed between the first and third surfaces 412 and 416. Also, the first or second power transfer unit 410 or 420 may be formed in various shapes so as to enhance an engaging force between the first or second power transfer unit 410 or 420 and the light source body 210.

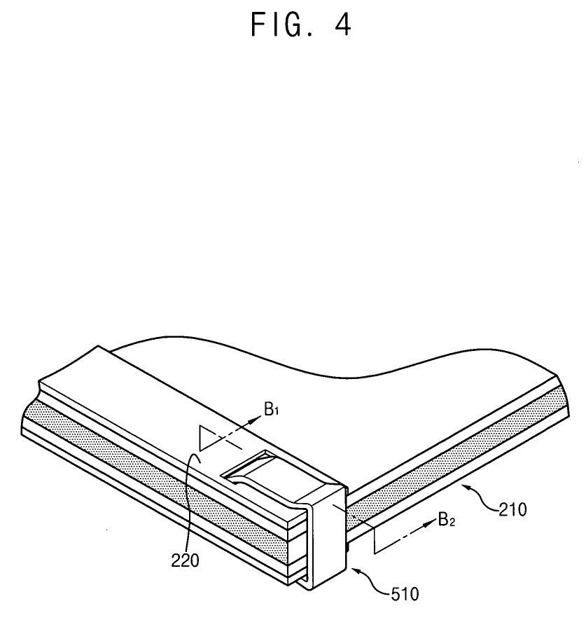

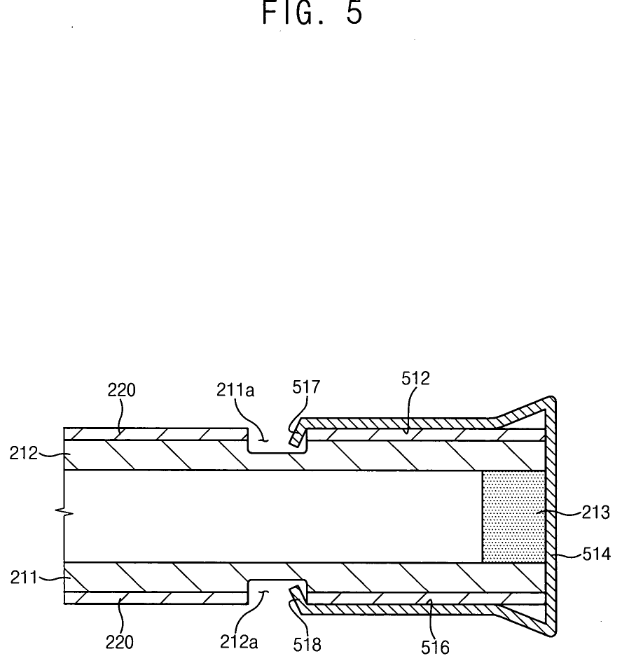

FIG. 4 is a perspective view showing a first power transfer unit 510 according to another exemplary embodiment. FIG. 5 is a cross-sectional view taken along the line B1-B2 of FIG. 4.

Referring to FIGS. 4 and 5, the first power transfer unit 510 includes a first surface 512 configured to make contact with the upper surface of the first external electrode 220 disposed on the upper outer surface of the light source body 210, a second surface 514 downwardly extended from the first surface 512 and disposed on the side outer surface of the light source body 210, and a third surface 516 extended from the second surface 514 and configured to make contact with the lower surface of the first external electrode 220 disposed on the lower outer surface of the light source body 210. The first and third surfaces 512 and 516 face each other. The first surface 512 includes a first bending portion 517 inwardly bent from an end of the first surface 512, and the third surface 516 includes a second bending portion 518 inwardly bent from an end of the third surface 516. First and second bending portions 517 and 518 extend toward each other.

The light source body 210 and the first external electrode 220 further each include a first engaging recess 211a formed at the upper surfaces thereof and engaged with the first bending portion 517 and a second engaging recess 212a formed at the lower surfaces thereof and engaged with the second bending portion 518. Particularly, the first engaging recess 211a is formed at a position where the first bending portion 517 is placed and the second engaging recess 212a is formed at a position where the second bending portion 518 is placed. Thus, when the first power transfer unit 510 clips on the first external electrode 220 disposed on the light source body 210, the first and second engaging recesses 211a and 212a are engaged with the first and second bending portions 517 and 518, respectively, resulting in enhanced engagement between the first power transfer unit 510 and the first external electrode 220 and light source body 210, preventing separation of the first power transfer unit 510 from the first external electrode 220 and light source body 210.

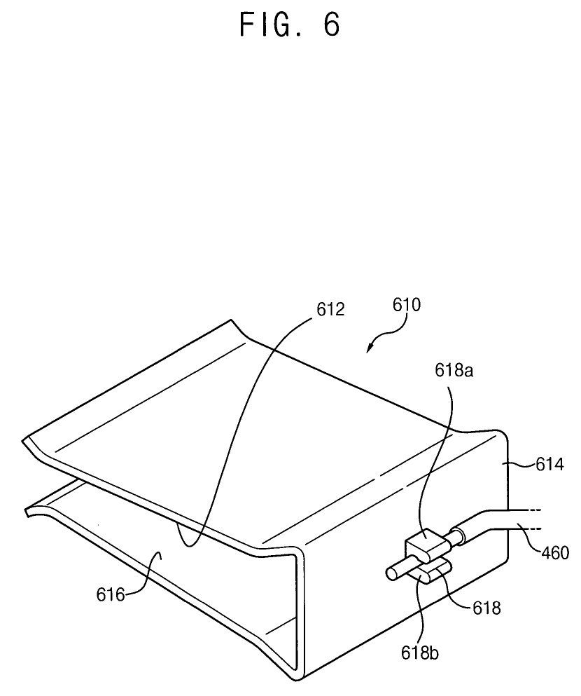

FIG. 6 shows a perspective view of a first power transfer unit 610 according to another exemplary embodiment. In FIG. 6, a power-line connection member 618 is formed on a first power transfer unit 610 to electrically connect the first power transfer unit 610 to either of the first and second power lines 460 and 470.

Still referring to FIG. 6, the first power transfer unit 610 includes a first surface 612 configured to make contact with the upper surface of the first external electrode 220 disposed on the upper outer surface of the light source body 210, a second surface 614 downwardly extended from the first surface 612 and disposed on the side outer surface of the light source body 210, a third surface 616 extended from the second surface 614 and configured to make contact with the lower surface of the first external electrode 220 disposed on the lower outer surface of the light source body 210, and the power-line connection member 618 disposed on the second surface 614. The first and third surfaces 612 and 616 face each other.

The power-line connection member 618 is formed such that the first power line 460 may be fixed to the power-line connection member 618. For example, the power-line connection member 618 includes first and second connection portions 618a and 618b facing each other and protruding from the second surface 614. The power-line connection member 618 may be formed by partially cutting an outwardly protruding portion from the second surface 614. The first power line 460 is inserted and fixed between the first and second connection portions 618a and 618b of the power-line connection member 618. Since the first power line 460 is combined with the first power transfer unit 610 via the power-line connection member 618, a soldering process is omitted in this embodiment.

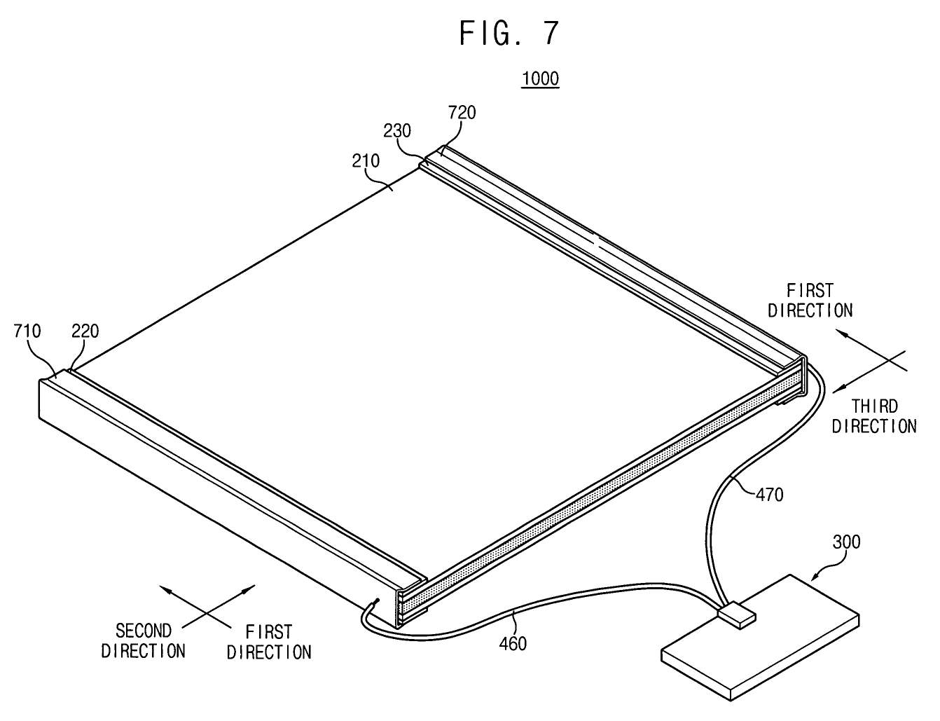

FIG. 7 is a perspective view showing a surface light source device according to another exemplary embodiment. In FIG. 7, the same reference numerals denote the same elements in FIG. 1, and thus the detailed descriptions of the same elements will be omitted.

Referring to FIG. 7, a surface light source device 1000 according to another exemplary embodiment of the present invention includes a surface light source 200, a first power transfer unit 710, a second power transfer unit 720 and an inverter 300. The surface light source 200 includes a light source body 210 and first and second external electrodes 220 and 230 disposed on outer surfaces of opposite ends of the light source body 210. The first and second external electrodes 220 and 230 extend in a first direction D1.

The first and second power transfer unit 710 and 720 clip on the two ends of the first and second external electrodes 220 and 230 disposed on the light source body 210 in a longitudinal direction of the first and second external electrodes 220 and 230. For example, the first power transfer unit 710 is connected to a first end of the light source body 210 on which the first external electrode 220 is disposed, in a second direction D2 substantially perpendicular to the first direction D1. The first power transfer unit 710 makes contact with the first external electrode 220 formed on the upper and lower surfaces of the light source body 210. The second power transfer unit 720 is connected to a second end of the light source body 210 on which the second external electrode 230 is disposed, in a third direction D3 opposite to the second direction D2. The second power transfer unit 720 makes contact with the second external electrode 230 formed on the upper and lower surfaces of the light source body 210.

Each of the first and second power transfer units 710 and 720 has a length substantially identical to a length of each the first and second external electrodes 220 and 230. As the contact areas between the first and second power transfer units 710 and 720 and the first and second external electrodes 220 and 230 increase, the electric or thermal property of the surface light source device 2000 is improved. Therefore, the first and second power transfer units 710 and 720 may function as an auxiliary heat sink due to the increased contact areas. Also, since the first and second power transfer units 710 and 720 may function as an absorbing member, an external impact is applied to the light source body 210 after passing through the first and second power transfer units 710 and 720 and a mechanical stability of the surface light source device 2000 is improved.

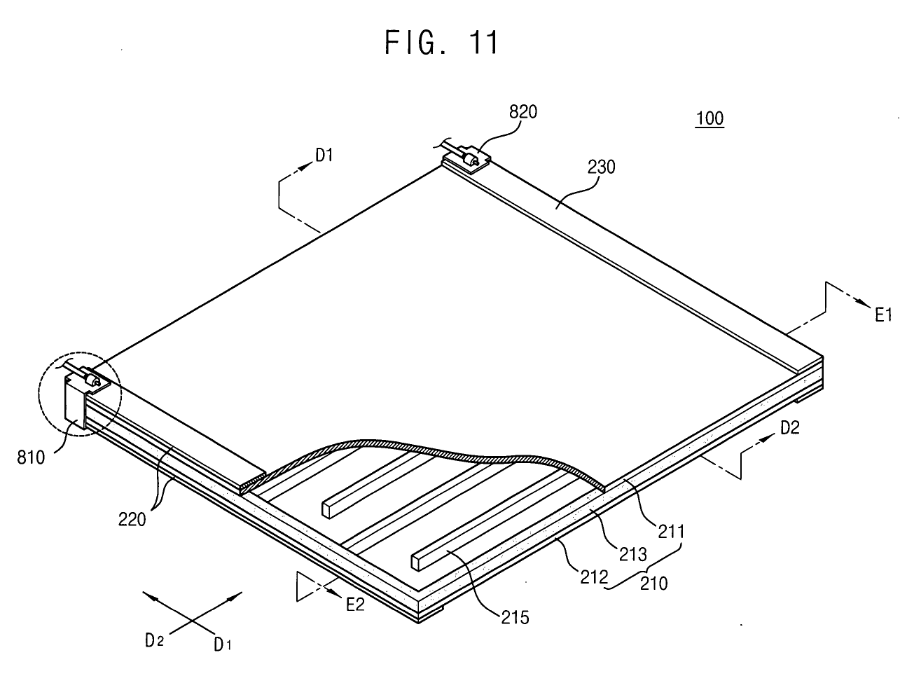

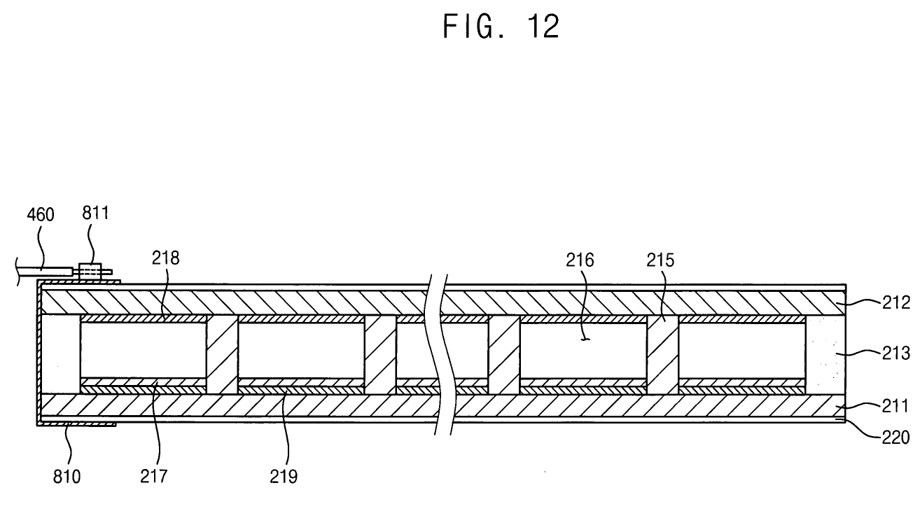

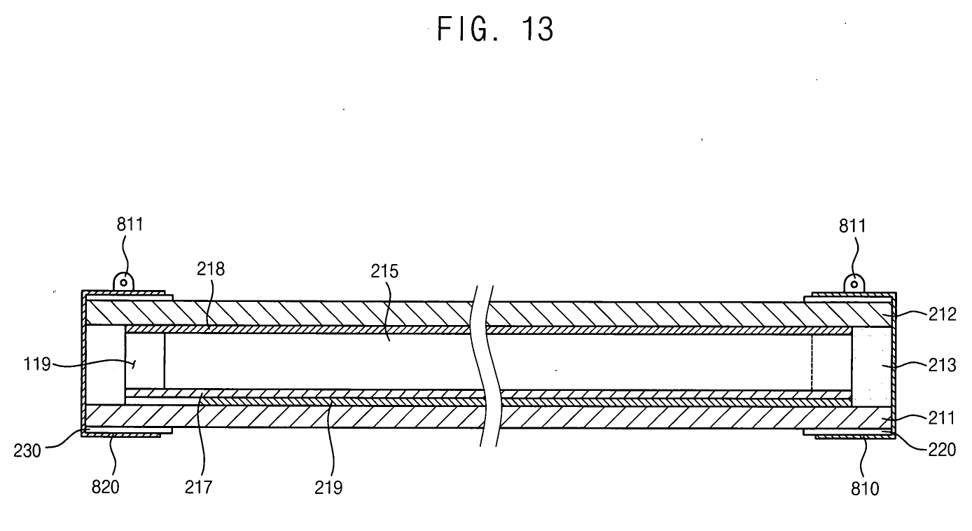

FIG. 11 is a perspective view showing a surface light source device according to another embodiment of the present invention. FIG. 12 is a cross-sectional view taken along the line D1-D2 of FIG. 11. FIG. 13 is a cross-sectional view taken along the line E1-E2 of FIG. 11.

Referring to FIGS. 11-13, first and second power transfer units 810 and 820 cover one end of the light source body 210, the first external electrode 220 and the second external electrode 230. The first and second power transfer units 810 and 820 are electrically connected to the first and second external electrodes 220 and 230, respectively. The first and second power transfer units 810 and 820 include a conductive metal material. Each of the first and second power transfer units 810 and 820 has a clip-shaped. For example, the first power transfer unit 810 electrically connects the first external electrode 220 disposed on the first substrate 211 with the first external electrode 220 disposed on the second substrate 212, and the second power transfer unit 820 electrically connects the second external electrode 230 disposed on the first substrate 211 with the second external electrode 230 disposed on the second substrate 212.

Thus, the first and second power transfer units 810 and 820 may simultaneously apply a power voltage provided from a power supply unit such as an inverter 300 (FIG. 1) to the first and second external electrodes 220 and 230, respectively. Each of the first and second power transfer units 810 and 820 includes a fixing portion 811 protruded therefrom so as to fix a first power line 460 (FIG. 1), to which the power voltage from the inverter 300 is applied.

The surface light source device 1000 further includes a first fluorescent layer 217 disposed on the first substrate 211, a second fluorescent layer 218 disposed on the second substrate 212, and a reflection layer 219 disposed between the first substrate 211 and the first fluorescent layer 217.

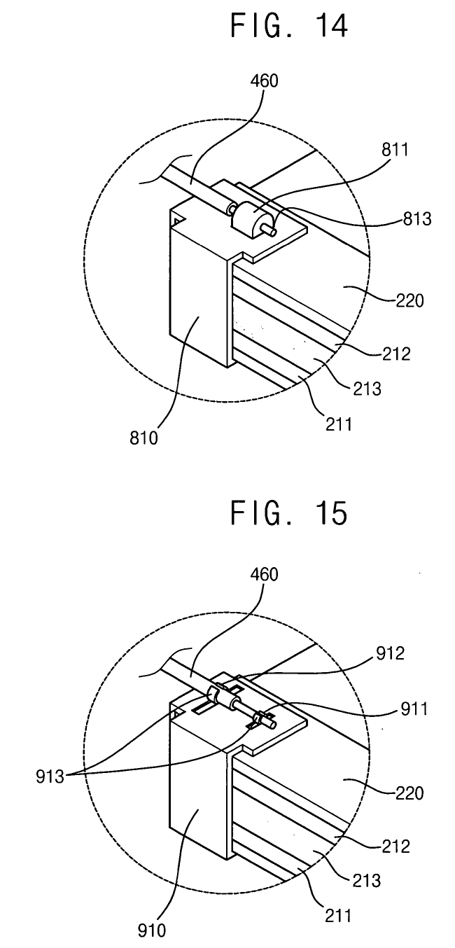

FIG. 14 is a partially enlarged view showing the first power transfer unit 810 of FIG. 11. In this exemplary embodiment, the second power transfer unit 820 has a structure substantially identical to that of the first power transfer unit 810, and thus a detailed description of the second power transfer unit 820 will be omitted.

Referring to FIG. 14, the first power transfer unit 810 includes the fixing portion 811 to fix the first power line 460 withdrawn from the inverter 300 (FIG. 1). The fixing portion 811 is protruded from the first power transfer unit 810 such that the fixing portion 811 has a substantially semicircular shape, and a hole 813 is formed through a center portion of the fixing portion 811 through which the first power line 460 passes. The fixing portion 811 and the first power transfer unit 810 include the same metal material. The fixing portion 811 fixes the first power line 460 to the first power transfer unit 810 such that the power voltage provided from the inverter 300 is applied through the first power transfer unit 810 to the first external electrode 220. Thus, the power voltage provided from the inverter 300 through the first power line 460 may be simultaneously applied to the first external electrode 220 on the outside of the first and second substrates 211 and 212.

Also, when the first power line 460 is soldered to the fixing portion 811 after inserted into the hole 813 of the fixing portion 811, workability may be improved and process time may be reduced because the power voltage is applied to the first external electrode 220 formed on the outside of the first and second substrates 211 and 212 through the first power line 460. Although FIGS. 11-14 show the fixing portion 811 formed on an upper portion of the first power transfer unit 810, the fixing portion 811 may be formed on a side portion or a lower portion of the first power transfer unit 810.

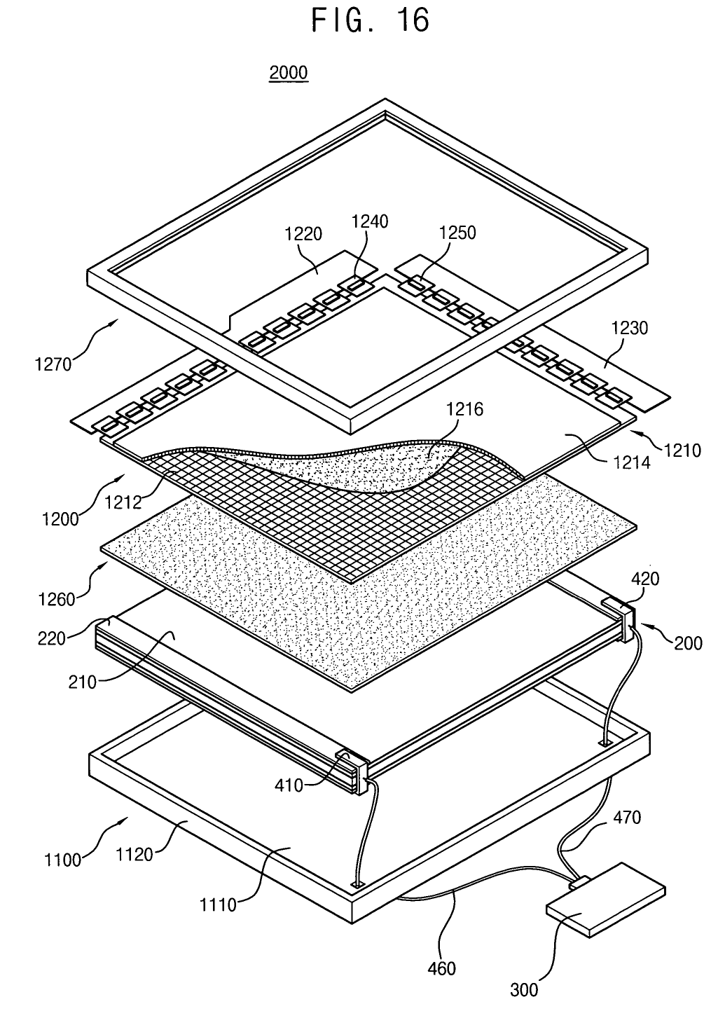

FIG. 15 is a partially enlarged view showing a power transfer unit according to another exemplary embodiment of the present invention. Referring to FIG. 15, a first power transfer unit 910 includes a first fixing portion 911 and a second fixing portion 912 so as to fix a first power line 460 to the first power transfer unit 910. The first and second fixing portions 911 and 912 are provided on the first power transfer unit 910 in parallel to each other in a longitudinal direction of the first power transfer unit 910.

The first fixing portion 911 is provided on the first power transfer unit 910 by partially cutting the first power transfer unit 910 and bending the cut portion, thereby providing a wing 913 that receives an inner wire of the first power line 460. When a predetermined force is applied to the wing 913 after the inner wire of the first power line 460 is received into the wing 913, the wing 913 grips the inner wire of the first power line 460. Since the first fixing portion 911 makes contact with the inner wire of the first power line 460 and fixes the inner wire of the first power line 460 to the first power transfer unit 910, the power voltage provided from the inverter 300 may be applied to the first external electrode 220 formed on the outside of the first and second substrates 211 and 212.

The second fixing portion 912 is provided on the first power transfer unit 910 by partially cutting the first power transfer unit 910 and bending the cut portion, thereby providing a wing 913 that receives a cable sheath of the first power line 460. The second fixing portion 912 fixes the first power line 460 to the first power transfer unit 910 such that the first power line 460 is not separated from the first power transfer unit 910 due to an external impact. The first and second fixing portions 911 and 912 may be formed on an upper side portion, a side portion or a lower portion of the first power transfer unit 910.

Thus, the power voltage provided from the inverter 300 through the first power line 460 may be simultaneously applied to the first external electrode 220 formed on the outside of the first and second substrates 211 and 212. Also, workability may be improved and process time may be reduced of the surface light source device 1000 because the power voltage is applied to the first external electrode 220 on the outside of the first and second substrates 211 and 212 through the first power line 460.

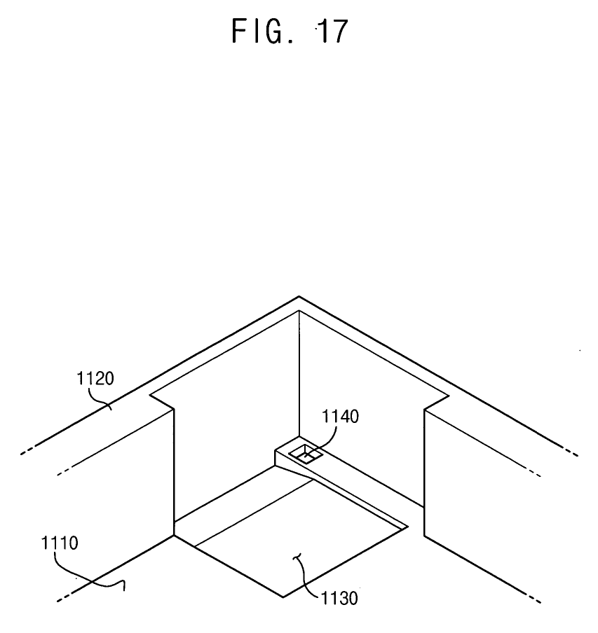

FIG. 16 is an exploded perspective view showing a liquid crystal display device according to an exemplary embodiment of the present invention. FIG. 17 is an enlarged view showing a portion of a receiving container shown in FIG. 16.

Referring to FIGS. 16 and 17, a liquid crystal display device 2000 includes the surface light source 200, the first and second power transfer units 410 and 420, a receiving container 1100, the inverter 300 and a display unit 1200. In this exemplary embodiment, the surface light source 200, the inverter 300, the first power transfer unit 410 and the second power transfer unit 420 have structures substantially identical to those of the surface light source 200, the inverter 300, the first power transfer unit 410 and the power transfer unit 420 of FIG. 1, and thus the detailed descriptions of the surface light source 200, the inverter 300, the first power transfer unit 410 and the second power transfer unit 420 will be omitted.

The display unit 1200 includes a liquid crystal display panel 1210 that displays an image, and a data printed circuit board 1220 and a gate printed circuit board 1230 that generates driving signals to drive the liquid crystal display panel 1210. The data and gate printed circuit boards 1220 and 1230 are electrically connected to the liquid crystal display panel 1210 via a data tape carrier package (data TCP) 1240 and a gate tape carrier package (gate TCP) 1250.

The liquid crystal display panel 1210 includes a thin film transistor (TFT) substrate 1212, a color filter substrate 1214 combined with the TFT substrate 1212, and liquid crystal 1216 interposed between the TFT substrate 1212 and the color filter substrate 1214. The TFT substrate 1212 includes a transparent glass substrate on which TFTs are arranged in a matrix configuration. Each of the TFTs includes a source electrode connected to a data line, a gate electrode connected to a gate line and a drain electrode connected to a pixel electrode (not shown) including a transparent conductive material. The color filter substrate 1214 is a substrate in which red, green and blue pixels (not shown) are formed in a thin film process. The color filter substrate 1214 includes a transparent conductive common electrode (not shown) formed therein.

The receiving container 1100 includes a bottom surface 1110 and a plurality of sidewalls 1120 extended from edges of the bottom surface 1110 so as to provide a receiving space. The surface light source 200 is received into the receiving space of the receiving container 1100. The sidewalls 1120 are extended in a direction substantially perpendicular to the bottom surface 1110, and make contact with four side surfaces of the surface light source 200, thereby preventing the separation of the surface light source 200 from the receiving container 1100. The receiving container 1100 may further include an insulating member (not shown) between the bottom surface 1110 and the surface light source 200. When the receiving container 1100 is formed with a metal, the insulating member prevents the electrodes of the surface light source 200 from making contact with the receiving container 1100.

The receiving container 1100 further includes a receiving recess 1130 having a shape corresponding to a shape of the first and second power transfer units 410 and 420. The receiving recess 1130 is formed at the bottom surface 1110 and the sidewalls 1120 corresponding to an area into which the first and second power transfer units 410 and 420 are placed. When the surface light source 200, to which the first and second power transfer units 410 and 420 are connected, is received into the receiving container 1100, the first and second power transfer units 410 and 420 are received into the receiving recess 1130, and also the lower surface and side surfaces of the light source body 210 make contact with the bottom surface 1110 and the sidewalls 1120 of the receiving container 1100, respectively.

The receiving container 1100 further includes an opening 1140 formed through the bottom surface 1110. The first and second power lines 460 and 470 enter into and exit from the opening 1140. The opening 1140 is formed adjacent to the receiving recess 1130. The first and second power lines 460 and 470 connected to the first and second power transfer units 410 and 420 are withdrawn from the receiving container 1100 through the opening 1140, and are electrically connected to the inverter 300.

The liquid crystal display device 2000 further includes an optical plate 1260 and a top chassis 1270. The optical plate 1260 is disposed between the surface light source 200 and the liquid crystal display panel 1200. The optical plate 1260 enhances brightness and uniformity of light emitted from the surface light source 200. For example, the optical plate 1260 may include a diffusion sheet that diffuses the light and a prism sheet that condenses the light. The liquid crystal display device 2000 may further include a mold frame (not shown) between the light source body 200 and the optical plate 1260 in order to support the optical plate 1260.

The top chassis 1270 is combined with the receiving container 1100 while surrounding edges of the liquid crystal display panel 1210. The top chassis 1270 prevents breakage of the liquid crystal display panel 1210 due to an external impact, and prevents from the separation of the liquid crystal display panel 1210 from the receiving container 1100.

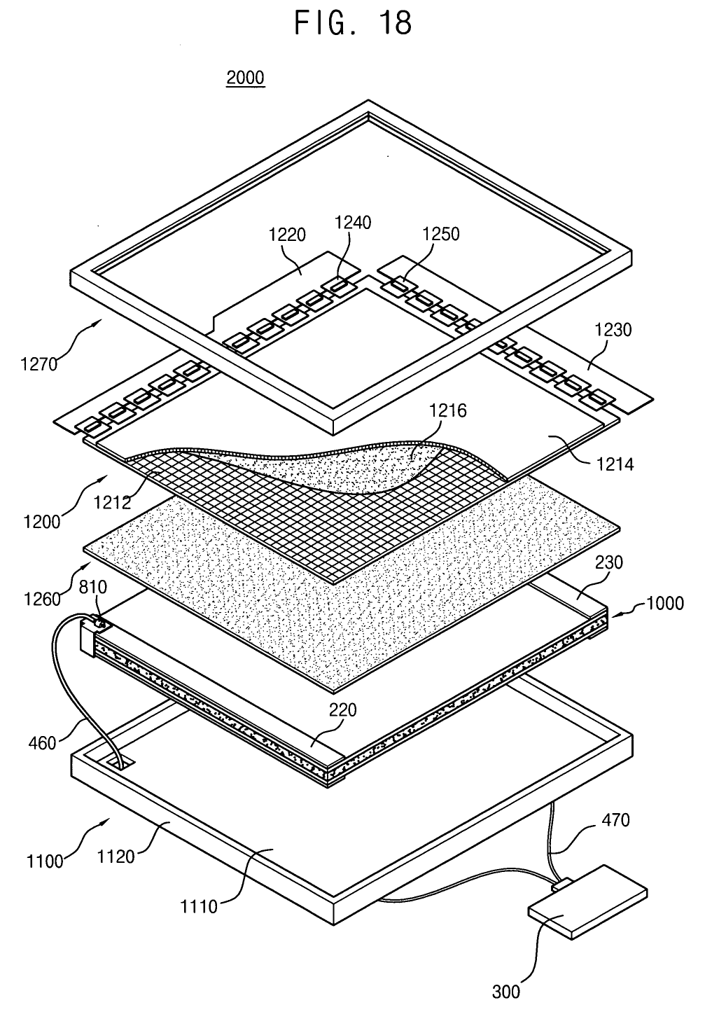

FIG. 18 is an exploded perspective view showing a liquid crystal display device according to the other exemplary embodiment of the present invention. In FIG. 18, the surface light source 200, the inverter 300, the first power transfer unit 410 and the second power transfer unit 420 have structures substantially identical to those of the surface light source 200, the inverter 300, the first power transfer unit 410 and the power transfer unit 420 of FIG. 11. The same reference numerals denote the same elements in FIGS. 1 and 16, and thus the detailed descriptions of the same elements will be omitted.

Referring to FIG. 18, the discharge voltage generated from the inverter 300 is applied to the first and second power transfer units 810 and 820 (FIG. 11) through the first and second power lines 460 and 470, respectively. Since the inner wire of the first and second power lines 460 and 470 are fixed to the first and second power transfer units 810 and 820 by the fixing portion 811, the discharge voltage applied to the first and second power transfer units 810 and 820 is be applied to the surface light source device 1100 through the first and second external electrodes 220 and 230. Therefore, the first and second power lines 460 and 470 are electrically connected to the first and second external electrodes 220 and 230.

Thus, the discharge voltage is applied to the first and second external electrodes 220 and 230 through the first and second power transfer units 810 and 820. In response to the discharge voltage applied to the discharge areas 216, the surface light source device 1000 performs a discharge operation. The first and second power lines 460 and 470 may be directly soldered to the first and second external electrodes 220 and 230, respectively.

Since a surface light source device according to exemplary embodiments of the present disclosure include first and second external electrodes disposed on an outer surface of a light source body and first and second power transfer units connecting the first and second external electrodes to an inverter, electrical and mechanical properties of the surface light source device is improved. Further, the surface light source device provides the light having uniform brightness distribution. Furthermore, the surface light source device uses one power line, instead of a plurality of wires withdrawn from an inverter. Thus, workability is improved and process time is reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A surface light source device, comprising:
a light source body including a discharge space to generate a light source;
at least one external electrode, which is disposed on an outer surface of one end of the light source body, is extended in a first direction, and applies a discharge voltage to the discharge space; and
at least one power transfer unit, combined with the at least one external electrode, to apply the discharge voltage to the at least one external electrode.

2. The surface light source device of claim 1, wherein the at least one power transfer unit includes a clip-shaped, which clips on the at least one external electrode disposed on the outer surface of the one end of the light source body.

3. The surface light source device of claim 1, further comprising:
an inverter to generate the discharge voltage; and
at least one power line connected between the at least one power transfer unit and the inverter.

4. The surface light source device of claim 1, wherein the at least one power transfer unit includes a conductive material having an elastic force.

5. The surface light source device of claim 2, wherein the at least one power transfer unit includes:
a first surface configured to make contact with the at least one external electrode disposed on an upper outer surface of the light source body;
a second surface disposed on a side outer surface of the light source body and downwardly extended from the first surface; and
a third surface configured to make contact with the at least one external electrode disposed on a lower outer surface of the light source body and extended from the second surface, the first and third surfaces facing each other.

6. The surface light source device of claim 5, wherein the at least one power transfer unit further includes a first bending portion outwardly bent from an end of the first surface and a second bending portion outwardly bent from an end of the third surface.

7. The surface light source device of claim 5, wherein the at least one power transfer unit further includes a first bending portion inwardly bent from an end of the first surface and a second bending portion inwardly bent from an end of the third surface.

8. The surface light source device of claim 7, wherein the light source body and the at least one external electrode each further include first and second engaging recesses; and
wherein the first engaging recesses are formed on the upper outer surface of the light source body and an upper surface of the at least one external electrode, respectively, and the second engaging recesses are formed on the lower outer surface of the light source body and a lower surface of the at least one external electrode, respectively, the first and second engaging recesses are engaged with the first and second bending portions, respectively.

9. The surface light source device of claim 5, wherein the at least one power transfer unit further includes a power-line connection member on the second surface to receive a power line; and
wherein the power-line connection member includes first and second portions, the first and second portions face each other and protrude from the second surface such that the power line is received between the first and second portions.

10. The surface light source device of claim 5, wherein the at least one power transfer unit clips on the at least one external electrode in a second direction substantially perpendicular to the first direction.

11. The surface light source device of claim 5, wherein the at least one power transfer unit clips on the at least one external electrode in the first direction and includes a length substantially identical to a length of the at least one external electrode.

12. The surface light source device of claim 3, wherein the at least one power transfer unit and the at least one power line are connected to each other by a soldering process.

13. The surface light source device of claim 5, wherein the at least one power transfer unit further includes a fixing portion formed on at least one of the first surface, the second surface and the third surface of the at least one power transfer unit to fix a power line to the at least one power transfer unit.

14. The surface light source device of claim 13, wherein the fixing portion is protruded from the at least one of the first to third surfaces such that a hole is formed through a center portion of the fixing portion, the power line passing through the hole.

15. The surface light source device of claim 14, wherein the fixing portion includes a substantially semicircular shape.

16. The surface light source device of claim 5, wherein the at least one power transfer unit further includes first and second fixing portions, formed on at least one of the first surface, the second surface and the third surface of the at least one power transfer unit, in parallel to each other in a longitudinal direction of the at least one power transfer unit, to fix a power line to the at least one power transfer unit.

17. The surface light source device of claim 16, wherein the first and second fixing portions each include a wing formed by cutting the at least one of the first surface, the second surface and the third surface of the at least one power transfer unit, the wing of the first fixing portion receives an inner wire of the power line, and the wing of the second fixing portion receives a cable sheath of the power line.

18. The surface light source device of claim 1, wherein the light source body further includes:
a first substrate;
a second substrate facing the first substrate and spaced apart from the first substrate; and
a sealing member disposed along ends of the first and second substrates,
wherein the discharge space is formed between the first and second substrates sealed by the sealing member.

19. The surface light source device of claim 18, wherein the light source body further includes at least one space-dividing member, which is arranged on the discharge space in the first direction to divide the discharge space into at least two discharge areas and is extended in a second direction substantially perpendicular to the first direction.

20. The surface light source device of claim 19, wherein the at least one space-dividing member includes a bar shape shorter than the discharge space in the second direction, and wherein the space-dividing member includes a first end connected to a first surface of the sealing member and a second end spaced apart from a second surface of the sealing member facing the first surface of the sealing member.

21. The surface light source device of claim 20, wherein the light source body further includes a connection path connecting the discharge areas, a discharge gas uniformly flowing in the discharge areas through the connection path.

22. The surface light source device of claim 19, wherein the light source body further includes:
a first fluorescent layer disposed on an inner surface of the first substrate except on the space-dividing member is disposed;
a second fluorescent layer disposed on an inner surface of the second substrate and facing the first fluorescent layer except on the space-dividing member is disposed; and
a reflecting layer disposed between the first fluorescent layer and the first substrate.

23. The surface light source device of claim 1, wherein the at least one external electrode is disposed on only an upper outer surface of the light source body, only a lower outer surface of the light source body, or both the upper and lower outer surfaces of the light source body.

24. A liquid crystal display device, comprising:
a surface light source, including:
a light source body including a discharge space to generate a light source; and
at least one external electrode, which is disposed on an outer surface of one end of the light source body, is extended in a first direction, and applies a discharge voltage to the discharge space;
at least one power transfer unit, combined with the at least one external electrode, to apply the discharge voltage to the at least one external electrode;
a receiving container to receive the surface light source; and
a liquid crystal display unit, disposed on an upper of the surface light source, to display an image with the light source generated from the surface light source.

25. The liquid crystal display device of claim 24, wherein the at least one power transfer unit includes a clip-shaped, which clips on the at least one external electrode disposed on the outer surface of the one end of the light source body.

26. The liquid crystal display device of claim 24, further comprising:
an inverter to generate the discharge voltage; and
at least one power line connected between the at least one power transfer unit and the inverter.

27. The liquid crystal display device of claim 24, wherein the at least one power transfer unit includes a conductive material having an elastic force.

28. The liquid crystal display device of claim 25, wherein the at least one power transfer unit includes:
a first surface configured to make contact with the at least one electrode disposed on an upper outer surface of the light source body;
a second surface disposed on a side outer surface of the light source body and downwardly extended from the first surface; and
a third surface configured to make contact with the at least one electrode disposed on a lower outer surface of the light source body and extended from the second surface, the first and third surfaces facing each other.

29. The liquid crystal display device of claim 28, wherein the at least one power transfer unit further includes a first bending portion outwardly bent from an end of the first surface and a second bending portion outwardly bent from an end of the third surface.

30. The liquid crystal display device of claim 28, wherein the at least one power transfer unit further includes a first bending portion inwardly bent from an end of the first surface and a second bending portion inwardly bent from an end of the third surface.

31. The liquid crystal display device of claim 30, wherein the light source body and the at least one external electrode each further include first and second engaging recesses; and
wherein the first engaging recess are formed on the upper outer surface of the light source body and an upper surface of the at least one external electrode, respectively, and the second engaging recess is formed on the lower outer surface of the light source body and a lower surface of the at least one external electrode, respectively, the first and second engaging recesses are engaged with the first and second bending portions, respectively.

32. The liquid crystal display device of claim 28, wherein the at least one power transfer unit further includes a power-line connection member on the second surface to receive a power line; and
wherein the power-line connection member includes first and second portions, the first and second portions face each other and protrude from the second surface such that the power line is received between the first and second portions.

33. The liquid crystal display device of claim 28, wherein the at least one power transfer unit clips on the at least one external electrode in a second direction substantially perpendicular to the first direction.

34. The liquid crystal display device of claim 28, wherein the at least one power transfer unit clips on the at least one external electrode in the first direction and includes a length substantially identical to a length of the external electrode.

35. The liquid crystal display device of claim 26, wherein the at least one power transfer unit and the at least one power line are connected to each other by a soldering process.

36. The liquid crystal display device of claim 28, wherein the at least one power transfer unit further includes a fixing portion formed on at least one of the first surface, the second surface and the third surface of the at least one power transfer unit to fix a power line to the at least one power transfer unit.

37. The liquid crystal display device of claim 36, wherein the fixing portion is protruded from the at least one of the first to third surfaces such that a hole is formed through a center portion of the fixing portion, the power line passing through the hole.

38. The liquid crystal display device of claim 37, wherein the fixing portion includes a substantially semicircular shape.

39. The liquid crystal display device of claim 28, wherein the at least one power transfer unit further includes first and second fixing portions, formed on at least one of the first surface, the second surface and the third surface of the at least one power transfer unit, in parallel to each other in a longitudinal direction of the at least one power transfer unit, to fix a power line to the at least one power transfer unit.

40. The liquid crystal display device of claim 39, wherein the first and second fixing portions each include a wing formed by cutting the at least one of the first to third surfaces of the at least one power transfer unit, the wing of the first fixing portion receives an inner wire of the power line, and the wing of the second fixing portion receives a cable sheath of the power line.

41. The liquid crystal display device of claim 26, wherein the receiving container includes:
a bottom surface;
sidewalls extended from edges of the bottom surface;
a receiving recess formed at the bottom surface and the sidewalls corresponding to an area into which the at least one power transfer unit is placed, the receiving recess having a shape corresponding to a shape of the at least one power transfer unit; and
an opening formed through the bottom surface, the at least one power line entering into and exiting from the opening.

42. The liquid crystal display device of claim 24, further including:
an optical plate disposed between the surface light source and the liquid crystal display unit.
